(19) United States
(12) Patent Application Publication
(10) Pub. No.: US 2006/0242368 A1
(43) Pub. Date: Oct. 26, 2006

(54) Method of Queuing and Related Apparatus

(76) Inventor: Cheng-Yen Huang, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 10/908,067

(22) Filed: Apr. 26, 2005

(51) Int. Cl. G06F 13/28

(52) U.S. Cl. 711/158

(57) ABSTRACT

A method of queuing and related apparatus. The present invention provides five queuing methods for moving, reducing, or changing characteristics of a plurality of units of a queuing system. The apparatus includes a selector coupled to a plurality of storage unit sets for transferring signals, a plurality of comparators each corresponding to a storage unit set for outputting signals, and a plurality of logic gate sets each corresponding to a storage unit set for initializing the storage unit set.

### BACKGROUND OF INVENTION

1. Field of the Invention

The present invention relates to a method of queuing and related apparatus of a queue system, more particularly, a method of reducing the number of required units of the queue system.

2. Description of the Prior Art

With rapid development in technology today, insufficient resources have always been a serious problem. Achieving greatest profit with least resources is also everyone's diligent goal. The principal of queuing theory is established on the foundation of the above-mentioned. The queuing theory is, for example, in our daily life, when groups of people are queuing up to buy movie tickets. A first person to arrive will be able to queue in front. The people in the front of the queue will have more selections. In a network system, as bandwidth is limited, therefore a user will have a higher priority to utilize the network as their waiting time for data transmission increases. In a brief explanation, the main objective of queuing is to allocate the limited resource to the person, matter, or thing, which has the need and to do so in an orderly, effective, and reasonable method.

For example, in the age of 8088 (circa 1980), as the speed of a central processing unit (CPU) was not fast enough, a memory usually had enough time to process the next data before the CPU completed processing the previous data. This did not slow down efficiency. However, in this present day, as performance of the CPU progresses rapidly, there are situations when the memory cannot keep pace with CPU performance. On average, speed performance of the CPU increases by 60% every year, but the speed increase of dynamic random access memory increases by only 7% each year. The overall performance is unable to improve. The main reason is due to the limit of a waiting status by the CPU. Waiting states are time-gaps in between two operations. During the waiting status, the CPU must wait for the memory to prepare for the next operation; hence, this causes the performance to not be able to improve. The best method to solve this problem was determined to be the utilization of cache technology.

In regards to the cache technology, please refer to the following explanation. Firstly, please refer to FIG. 1. FIG. 1 illustrates a diagram of a memory hierarchy architecture 100 of a conventional computer system. As shown in FIG. 1, a cache memory is located at a level in between the CPU and the main memory of the memory hierarchy architecture 100. The principle of the cache is to utilize a high-speed memory to store program codes or data that were recently utilized. In this way, there is no need to access the system memory each time that data is utilized repeatedly. The program frequently accesses memory data from the same region, therefore, the cache helps to increase the performance of the system's efficiency. Usually the size of the quickest first level cache memory (L1 cache) has only several thousand to several ten thousands of bytes, because L1 cache is located internally in the CPU. As a result, L1 cache has the greatest utilization performance. The size of a slightly slower second level cache memory (L2 cache) has up to a million bytes. The L2 cache in some systems (for example the Pentium series) is located on the motherboard, whereas in other systems it is located internal to the CPU.

In the computer system, in comparison to the main memory, the speed of the cache memory is faster, although the volume is smaller because cache memory is expensive. This expense is the main reason that the computer system's main memory is implemented by dynamic random access memory (DRAM), and the cache memory is implemented by static random access memory (SRAM). The DRAM comprises electric capacities. The process of discharging the electric capacity consumes time, however, to maintain the data in the DRAM (or electric current leak), once a memory cell is accessed, the memory cell must be updated. Therefore, the memory cell of the DRAM will be updated every 4 to 16 milliseconds. This updating process reduces the overall performance. Alternately, the SRAM is composed of a flip-flop. Please refer to FIG. 2. FIG. 2 illustrates a circuitry diagram of a flip-flop 200. As shown in FIG. 2, the flip-flop 200 is composed of electric transistor and resistance, therefore if power is constantly supplied to the flip-flop 200, then the flip-flop 200 will maintain at a stable state. Therefore, the SRAM does not necessary need to be updated and its speed can surpass that of the DRAM's up by up to ten times faster. However, the implementation of the flip-flop is more complex. This causes the SRAM to be more expensive. Because of the expense of the SDRAM, its scope of utilization is limited.

The working principle of cache memory is to predict the main memory block that the CPU wants to access. Furthermore, when the CPU is about to access the memory block the data of the memory block will be loaded into the cache memory and after the CPU accessed the data of the memory block, the data will be saved in the cache memory. Therefore, whenever data of a memory address is to be accessed, the CPU can attempt to obtain this data via the cache memory. If the cache memory does not have this data, then the CPU will halt until the data is loaded into the cache memory from the main memory.

Please refer to FIG. 3 and FIG. 4. FIG. 3 illustrates an architectural diagram of a conventional main memory 300. FIG. 4 illustrates an architectural diagram of a conventional cache memory 400. In FIG. 3, the conventional main memory 300 is formed by 2ⁿ addressable characters, each character having a unique n address. In order to realize function of line mapping, design of the main memory is composed by a plurality of fixed length blocks, and each block comprises a K character, therefore, the main memory has (M=2ⁿ/K) block. The conventional cache memory 400 is divided into C line, each line comprises K character. The C line of the cache memory 400 is by far smaller than M block of the memory body 300. Therefore, in any situation, only a block set of the memory 300 will correspond to the C line of the cache memory 400. When a memory block of the main memory 300 is read, the block data will be transmitted to a line in the cache memory 400. However, because the M block of the main memory 300 is by far greater than the C line of the cache memory 400, any line of the cache memory 400 will never always correspond to only a block of the main memory 300. In this way, each line of the cache memory 400 comprises a tag, for indicating the line corresponding to a block of the main memory 300, and each tag is usually a part of the main memory address.

The performance of the cache memory is determined by the success rate of the cache memory in providing the data required by the CPU. This is known as the efficiency of the cache memory hit. Hit means that the data needed by the CPU is in the cache memory. The opposite is when the data needed by the CPU is not in the cache memory and this is known as a miss. The miss of the cache memory can be divided into three categories:

1. Compulsory miss: there is not data when the cache memory is in an initial state, therefore when the CPU first accesses a memory block for data, inevitably, a fault situation happens. Therefore, the compulsory miss is also known as cold start or first reference.

2. Capacity miss: when the data needed in the memory block by an executing program surpasses the capacity of the cache memory. The insufficient cache memory also causes a fault to occur.

3. Conflict miss: when the set associative mapping or the direct mapping (set associative mapping and direct mapping will be mentioned later) approaches are utilized, if excess memory blocks correspond to a set or a line then the conflict fault occurs. The conflict fault is also known as a collision miss or interference miss.

Therefore, when the CPU is unable to find the data required via the cache memory, a miss occurs and then the data will be fetched from lower lever and transmitted to upper lever. In order to improve the performance of the cache memory a hit ratio has to be increased (ratio of hits of all memory access) or to reduce a miss ratio (=1−hit ratio). In the prior art, there are many methods to improve the performance of the cache memory; one of them is to increase the size of the cache memory. Since larger cache memory can store more data, the number of hits inevitably will increase. However, there is a limit to the effect of increasing the size of the cache memory. When the cache memory is increased to a certain degree, any additional increase will no longer improve performance. In general, the cache memory must be small enough so that the overall average cost per bit of the cache memory is close to the overall average cost per bit of the main memory. At the same time, the cache memory must be large enough so that the overall average access time of the cache memory is close to the overall average access time of the cache memory when only operating without the main memory. Furthermore, the larger cache memory will require more logic gates. These additional gates may cause the large cache memory to be slower than the smaller cache memory. The cache memory size is also limited due to utilization area of chipset. Therefore, those skilled in the art will know that most suitable cache memory size in a multitasking system is 256,000 characters.

Mapping discloses a line connection between the block of the main memory 300 and the cache memory 400. As mentioned previously, as C line of the cache memory 400 is by far smaller than M block of the main memory 300 the line sequence of each cache memory is shared by several memory blocks. As a result, when a block is read into a line of the cache memory, data of another block is deleted by another line of the cache memory, but the function of mapping is to reduce the probability of a deleted block being stored again within a predetermined time. Those skilled in the art will know that there are three types of mapping: direct mapping, fully associative mapping, and N-way set associative mapping.

1. Direct mapping allocates a block of the main memory to correspond to a predetermined line of the cache memory;

2. Fully associative mapping does not define that a block of the main memory must correspond to a predetermined line of the cache memory; therefore, a block of the main memory can correspond to any line of the cache memory;

3. Set associative mapping is a compromise of the above two methods, it divides the cache memory into a plurality of direct mapping sets, each set comprises a comprised predetermined number of lines.

In the practical application, the direct mapping and the set associative mapping are often utilized. The direct mapping is utilized in the second level of the cache memory located on the motherboard while the set associative mapping is utilized in the cache memory of the CPU. Technical detail of the conventional mapping method is not the main objective of the present invention, therefore, it will not be further mentioned.

In the above-mentioned, when data is loaded into a line of the cache memory, another line must be deleted. In the direct mapping of the cache memory, as each memory block only corresponds to a line of cache memory, therefore a replacement algorithm of the cache memory will not be difficult. However, in the fully associative mapping of the cache memory, all blocks can be replaced, and in the memory of the set associative mapping, a block of the sets selected must be selected, therefore the replacement algorithm of the cache memory is more difficult. Generally, the four most commonly replacement algorithms utilized by the cache memory are:

1. Least recently used (LRU): in the most recent time, the least utilized will be replaced;

2. First in first out (FIFO): the earliest utilized will be replaced;

3. Least frequently used (LFU): in the most recent time, the least frequent utilized will be replaced;

4. Random: replaced by random selection.

In the four algorithms above, the LRU provides the best performance for the cache memory, therefore the LRU is the most often utilized algorithm by the cache memory, but the implementation of the LRU is actually the most complex.

The resource is limited; therefore allocating limited resources is a serious issue. Especially in a computer system, high velocity of the cache memory can provide resources needed when the CPU operates, however production cost of the cache memory is higher by comparison. Due to this higher cost, manufacturers today are focused on reducing cache memory to achieve higher performance.

### SUMMARY OF INVENTION

The claimed invention discloses a method of queuing and related apparatus of a queue system.

The claimed invention discloses a method of queuing for a queue system, the queue system comprises a plurality of units, each unit is positioned in an order according to a predetermined rule, the queuing method comprising: extracting and positioning a unit into a first priority position of the queue system according to an extract command.

The claimed invention further discloses a method of queuing for a queue system, the queue system comprises a plurality of units, each unit is positioned in an order according to a predetermined rule, the queuing method comprising: inserting and positioning a unit into a first priority position of the queue system according to an insert command, and removing a unit located in a last position of the queue system.

The claimed invention further discloses a method of queuing for a queue system, the queue system comprises a plurality of units, each unit is positioned in an order according to a predetermined rule, the queuing method comprising: performing a search on the queue system without changing the sequence of each unit according to a search command.

The claimed invention further discloses a method of queuing for a queue system, the queue system comprises a plurality of units, each unit is positioned in an order according to a predetermined rule, the queuing method comprising: extracting from a plurality of units and positioning the unit of a last position into a first priority position of the queue system according to a multi-extract command.

The claimed invention further discloses a method of queuing for a queue system, the queue system comprises a plurality of units, each unit is positioned in an order according to a predetermined rule, the queuing method comprising: changing characteristics of a unit to the characteristics according to a changing characteristics command.

A controller for a storage device, the storage device comprises a plurality of storage unit sets forming into a sequence, each storage unit set comprises a plurality of storage units, the controller comprising: a selector coupled to the plurality of storage unit sets for selecting a storage unit set of a plurality of storage unit sets to transmit signals to a predetermined storage unit set according to a predetermined request, a plurality of comparators each comparator corresponding to a storage unit set for outputting signals from an output port of the storage unit set according to an extract request signal, and a plurality of logic gate sets each logic gate set corresponding to a storage unit set for controlling initialization of the storage unit set according to an enable signal and the extract request signal.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a diagram of a memory hierarchy architecture of a conventional computer system.

FIG. 2 illustrates a circuitry diagram of a flip-flop.

FIG. 3 illustrates an architectural diagram of a conventional main memory.

FIG. 4 illustrates an architectural diagram of a conventional cache memory.

FIG. 5 illustrates a diagram of a queue system according to the present invention.

FIGS. 6, 8, 10, 12, and 14 illustrate a flowchart of a flow of a queue system according to the present invention.

FIGS. 7, 9, 11, 13, and 15 illustrate a transaction diagram of data structures.

FIGS. 16, 17, 18, and 19 illustrate a data structure diagram of a practical embodiment of the present invention.

FIG. 20 illustrates a design diagram of a hardware implementation of the flow according to the present invention.

FIG. 21 illustrates a situational diagram of the design of a hardware implementation of FIG. 20 executing a Reset action.

FIG. 22 illustrates a situational diagram of the design of a hardware implementation of FIG. 20 executing a GlobalExtractin action.

FIG. 23 illustrates a situational diagram of the design of a hardware implementation of FIG. 20 extracting and positioning a data set unit in fourth position of a data set unit chain to top position.

FIG. 24 illustrates a situational diagram of the design of a hardware implementation of FIG. 20 extracting and positioning a data set unit in a first position of a data set unit chain to top position.

FIG. 25 illustrates a situational diagram of data set units not required in the design of a hardware implementation of FIG. 20.

FIG. 26 illustrates a diagram of a basic component formed by the design of a hardware implementation according to FIG. 20.

FIG. 27 illustrates a diagram of a chain of components.

FIG. 28 illustrates a diagram of a controller of a storage device.

FIGS. 29, 30 illustrate a diagram of a four directional set associative cache memory.

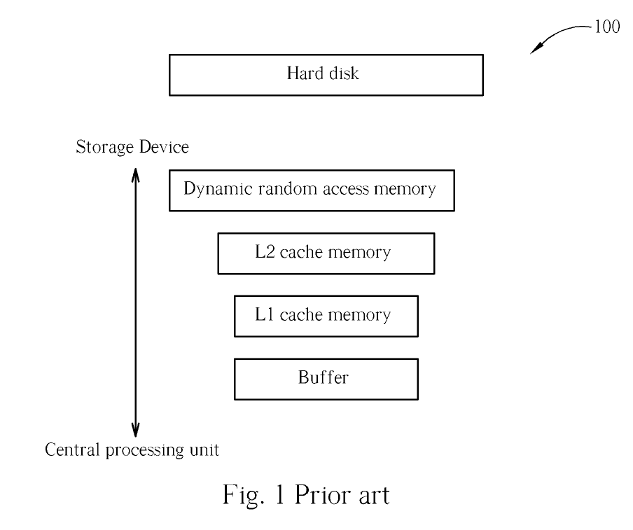

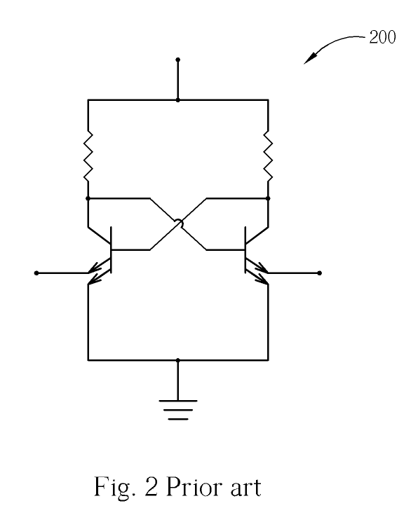

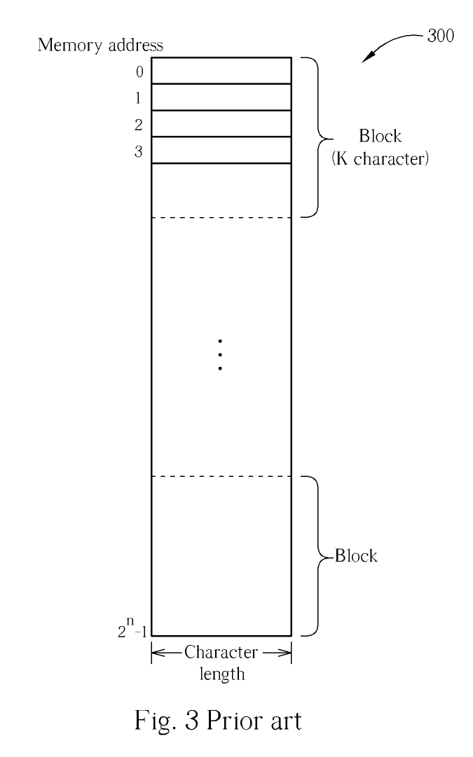

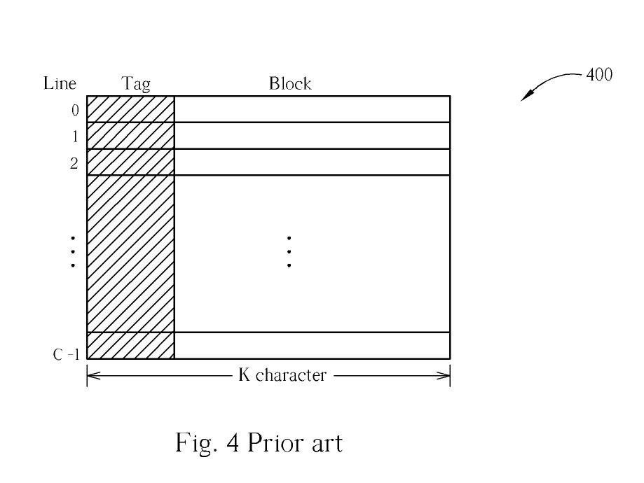

### DETAILED DESCRIPTION

Data Structure:

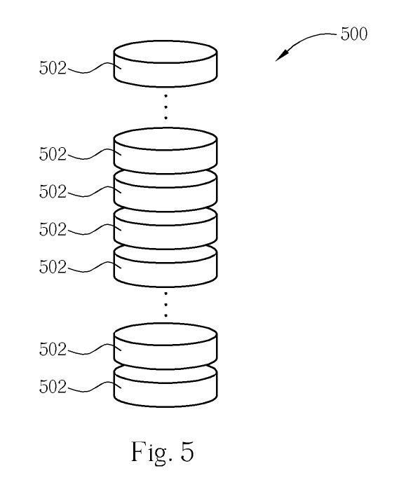

Please refer FIG. 5. FIG. 5 illustrates a diagram of a queue system 500. The queue system 500 comprises a plurality of units 502. The queue system 500 can be viewed as a data structure, the plurality of units 502 are arranged in a sequence from top to bottom in FIG. 5, a unit 502 can be viewed as a data set of the data structure. For example, the plurality of unit 502 can be viewed as data stored in memory cell of cache memory, when required by demand of the central processing unit (CPU), for providing to the CPU, and the queue system 500 can be viewed as a structure of the data stored in the memory cell of the cache memory arranged from top to bottom according to the amount of utilization.

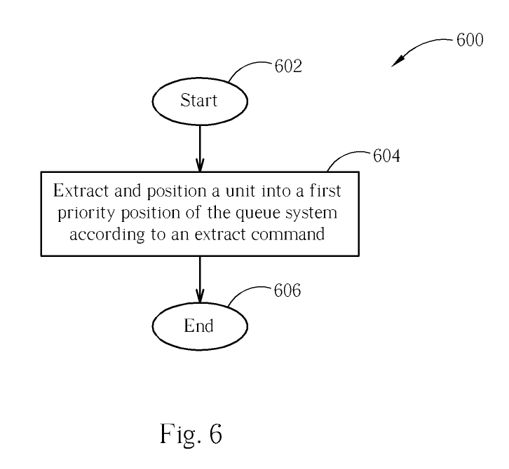

Please refer to FIG. 6. FIG. 6 illustrates a flowchart of flow 600 of a queue system according to the present invention. The flow 600 comprises the following steps:

Step 602: start;

Step 604: extract and position a unit into a first priority position of the queue system according to an extract command;

Step 606: end.

Therefore, according to the flow 600, when a unit 502 of the queue system 500 conforms to the extract command, the unit is extracted to a specific position. Continuing with the example mentioned above, if the data required by the CPU is stored in a specific unit 502 of the queue system 500, the data is then extracted and positioned into the top position which is a position that is most recently utilized according to the flow 600 of the present invention.

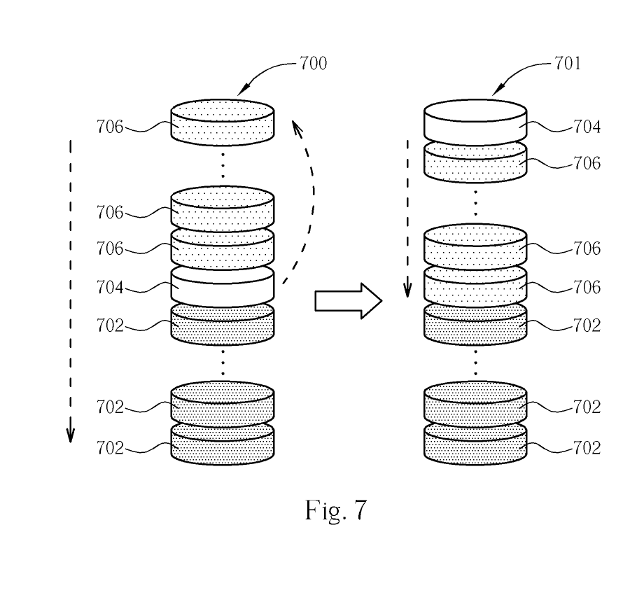

Please refer to FIG. 7. FIG. 7 illustrates a transaction diagram of data structures (queue system) 701, 701 according to the flow 600 of FIG. 6. The data structure 700 comprises a plurality of data sets. For example, data set 704 is required by a system. That system is located in between a plurality of data sets 706 and a plurality of data sets 702 of the data structure 700. According to the flow 600 and when the data set 704 conforms to the demand, the flow 600 can extract the data set 704 from the data structure 700 and position it into top position (first priority position) of the data structure 700 to form the data structure 701. In the data structure 701, the data set 702 remains in its original position, but the data set 706 moves down a position while maintaining the original sequence. In short, as shown in FIG. 7, when the data set 704 of the data structure 700 is read, the flow 600 places the data set 704 to the first priority position and other data sets 702, 706 remain in original sequence to form the data structure 701. Therefore, when the system needs to read the data set 704 of the data structure 701 again, as the data set 704 is located on the top layer of the data structure 701, thus this system can reduce time.

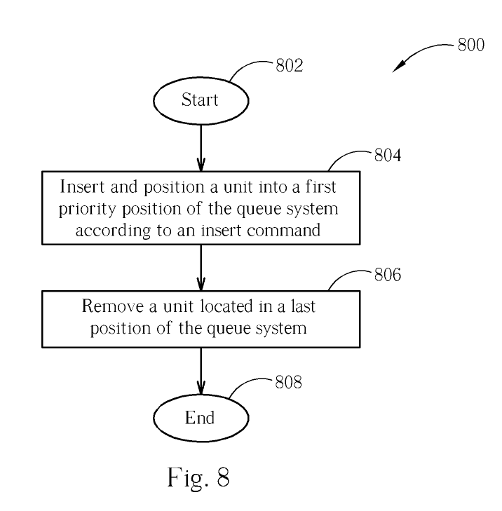

Please refer to FIG. 8. FIG. 8 illustrates a flowchart of flow 800 of a queue system according to the present invention. The flow 800 comprises the following steps:

Step 802: start;

Step 804: insert and position a unit into a first priority position of the queue system according to an insert command;

Step 806: remove a unit located in a last position of the queue system;

Step 808: end.

Therefore, according to the flow 800, the present invention is capable of inserting and positioning a unit into top layer (first priority position) and a unit located in a lowest layer (a last position) of the queue system is removed. For example, if data required by the CPU of the computer system does not exist in the cache memory, as the data stored in the memory cells of the cache memory cannot satisfy the requirement of the CPU, according to the flow 800 of the present invention, the cache memory can remove the last position (the least utilized) to accommodate the new data which the central processor requires.

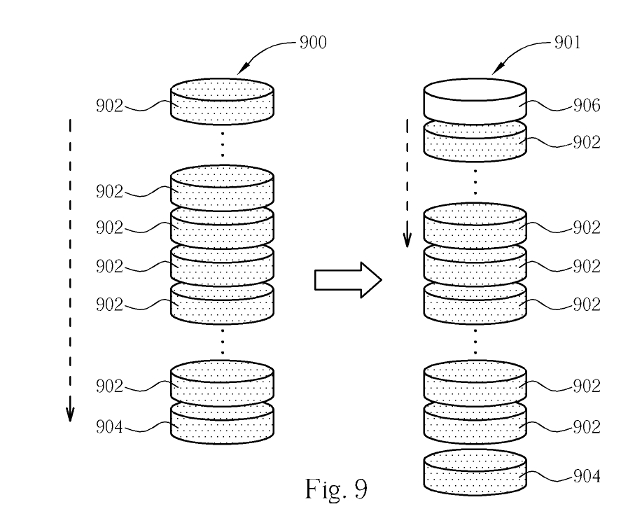

Please refer to FIG. 9. FIG. 9 illustrates a transaction diagram of data structures (queue system) 900, 901 according to the flow 800 of FIG. 8. The data structure 900 comprises a plurality of data sets 902 arranged in a sequence and a data set 904 located in lowest (last) position of the data structure 900. When data required by a system is stored in the data structure 900, the system is capable of extracting and positioning the data required to first priority position of the data structure 900 according to the flow 600 of the present invention. However, if data required by the system does not exist in the data structure 900, then the data set 904 located at the lowest position in the data structure 900 will be removed. Additionally, the required data set 906 is then placed to a first priority position of the data structure 900 according to the flow 800 of the present invention forming the data structure 901. In short, as shown in FIG. 9, when the required data set 906 does not exist in the data structure 900, the present invention is capable of positioning the data set 906 into the top position of the data structure 900 according to the flow 800 of the present invention, to form the data structure 901. Therefore, when the system reads the data set 906 again, the data structure 901 is located at the top position according to the flow 600 reading the data set 906.

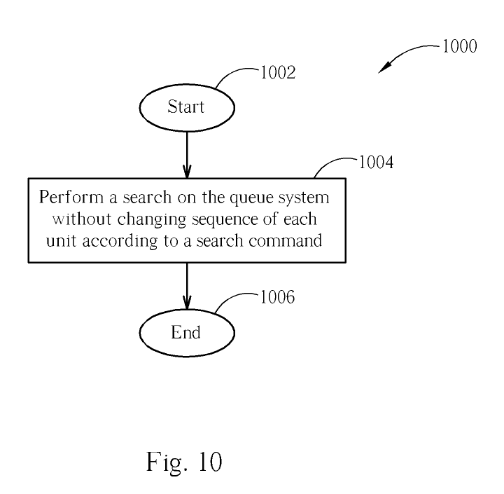

Please refer to FIG. 10. FIG. 10 illustrates a flowchart of flow 1000 of a queue system according to the present invention. The flow 1000 comprises the following steps:

Step 1002: start;

Step 1004: perform a search on the queue system without changing sequence of each unit according to a search command;

Step 1006: end.

Therefore, according to the flow 1000, this invention performs a search on the queue system according to a search command, without changing sequence of each unit. For example, if the CPU wants to retrieve data stored in each memory cell of the cache memory, according to the flow 1000 of the present invention to perform the search, at the same time when the search is performing, the sequence of each unit will not be changed.

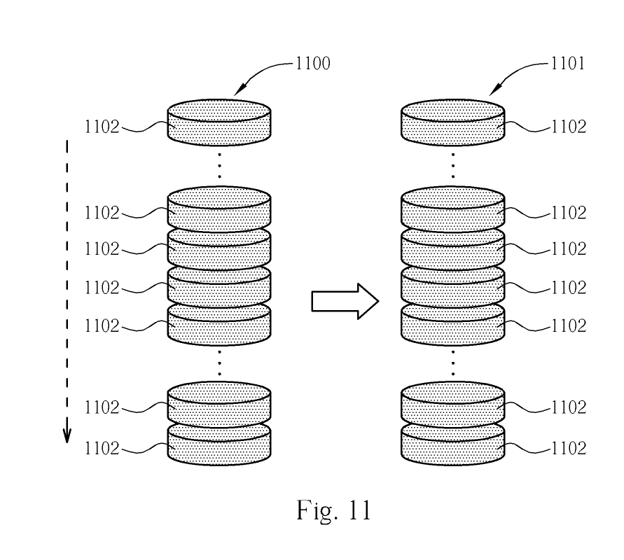

Please refer to FIG. 11. FIG. 11 illustrates a transaction diagram of data structures (queue system) 1100, 1101 according to the flow 1000 of FIG. 10. The data structure 1100 comprises a plurality of data sets 1102 arranged in a sequence. When a system performs a search on the data structure 1100, according to the flow 1000 of the present invention, the sequence of the data sets of the data structure 1100 will not change, therefore the data structure 1101 and the data structure 1100 are actually equal structures. In short, according to the flow 1000 of the present invention, when searching the data structure 1100, there is no need to change the array of each data set 1102 of the data structure 1100 to the sequence of the data structure 1100. As a result, the data structure 1101 is formed after the search of data structure 1100 is complete; the sequence of the data set 1102 is not changed. The overall performance can be improved based on the search result.

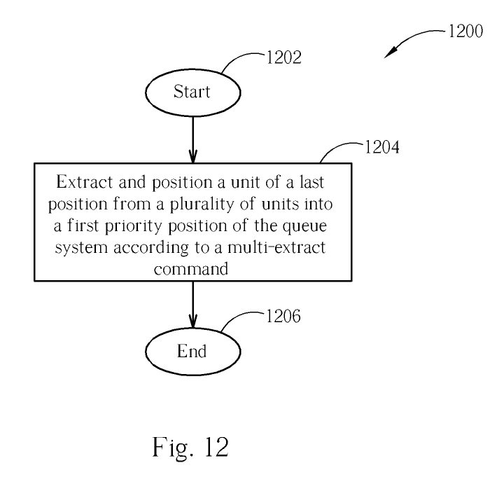

Please refer to FIG. 12. FIG. 12 illustrates a flowchart of flow 1200 of a queue system according to the present invention. The flow 1200 comprises the following steps:

Step 1202: start;

Step 1204: extract and position a unit of a last position from a plurality of units into a first priority position of the queue system according to a multi-extract command;

Step 1206: end.

Therefore, according to the flow 1200, the present invention is capable of extracting a unit of a last position that conforms to a command into a first priority position of the queue system according to the multi-extract command. For example, in the computer system, if the data needed by the CPU corresponds to two predetermined units in the queue system, then the flow 1200 is able to extract and position the unit from a lower layer to the top position of the queue system.

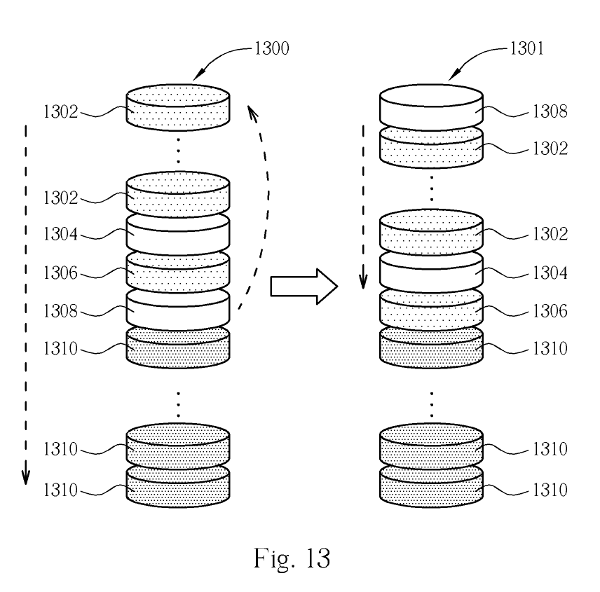

For example, if the data sets required are two, please refer to FIG. 13. FIG. 13 illustrates a transaction diagram of data structures (queue system) 1300, 1301 according to the flow 1200 of FIG. 12. The data structure 1300 comprises a plurality of data sets 1302, a data set 1304, a data set 1306, a data set 1308, and a plurality of data sets 1310 arranged sequentially in a sequence. For example, the data set 1304 is required and is situated in between the plurality of data sets 1302 and the data set 1306 of the data structure 1300. Additionally, the required data set 1308 is situated between the data set 1306 and the plurality of data sets 1310 of the data structure 1300. Therefore, the flow 1200 of the present invention extracts and places the data set 1308 located in the lower layer of the required data set in 1304 and 1308 to the top position of the data structure 1300 to form the data structure 1301. As shown in FIG. 13, after the flow 1200 of the present invention extracts the data set 1308 to the top position, the sequence of the data sets 1302, 1304, 1306 is not changed, however, they are moved a position down. Therefore, in the data structure 1300, the data set located in between the required data set 1304 and the data set 1308 is the data set 1306, and in the data structure 1301, the data set located in between the required data set 1304 and the data set 1308 becomes a plurality of data sets 1302.

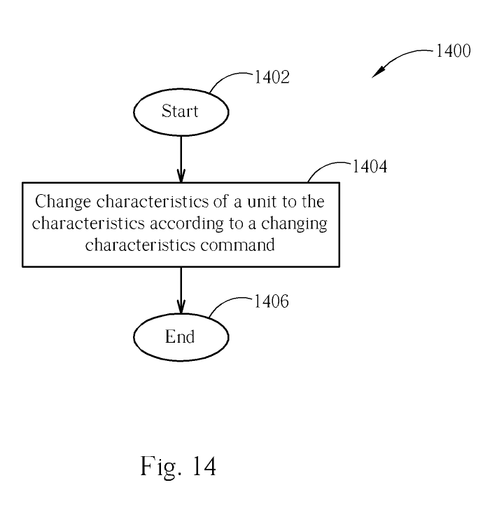

Please refer to FIG. 14. FIG. 14 illustrates a flowchart of flow 1400 of a queue system according to the present invention. The flow 1400 comprises the following steps:

Step 1402: start;

Step 1404: change characteristics of a unit to the characteristics according to a changing characteristics command;

Step 1406: end.

Therefore, according to the flow 1400, the present invention is capable of changing characteristics of a unit to the characteristics instructed according to a changing characteristics command, at the same time, maintaining the sequence of the units of the queue system. For example, in the computer system, the flow 1400 is capable of changing characteristics of data stored in a memory cell of the cache memory and yet maintaining the sequence of data stored in all memory cells.

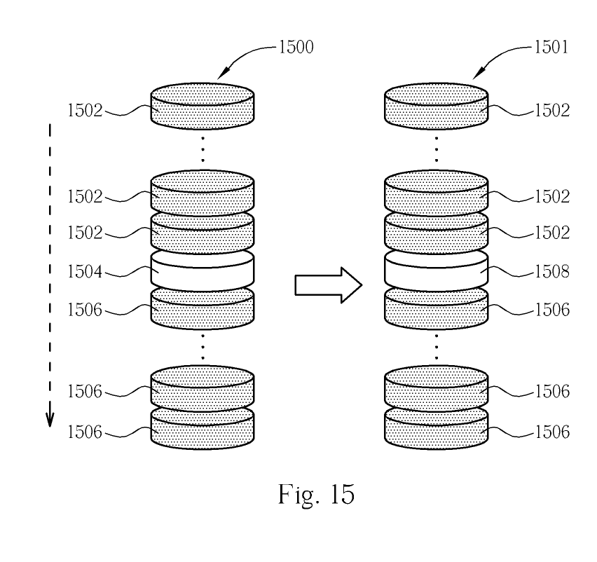

Please refer to FIG. 15. FIG. 15 illustrates a transaction diagram of data structures (queue system) 1500, 1501 according to the flow 1400 of FIG. 14. The data structure 1500 comprises a plurality of data sets 1502, a data set 1504 and a plurality of data sets 1506 arranged in a sequence. For example, when a system wants to change characteristics of the data set 1504, the flow 1400 will not change the order sequence of each data set of the data structure 1500 except that the characteristics of the data set 1504 are changed into the data set 1506. Therefore, the sequence of each data set of the data structure 1501 will remain identical to the data structure 1500 except for the characteristics of the data set 1504 being changed into the data set 1506. In short, as shown in FIG. 15, when the system needs to change the characteristics of the data set 1504, the flow 1400 will not change the sequence of each data set of the data structure 1500. It only aims at changing the characteristics of a data set. Thus, when the data set (1504 originally) is read, what is read will become the data set 1506.

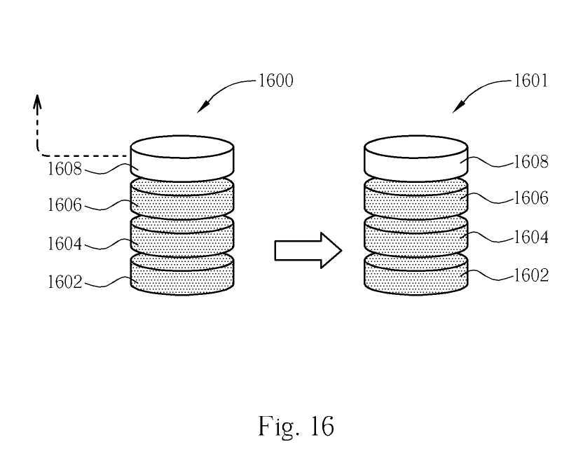

Therefore, according to the flow 600, 800, 1000, 1200, and 1400, the queue system 500 is capable of extracting, inserting, searching and changing characteristics of data set. For example, please refer FIG. 16. FIG. 16 illustrates a data structure diagram of a practical embodiment of the present invention. In FIG. 16, a data structure 1600 comprises data sets 1602, 1604, 1606, and 1608 arranged in a sequence from bottom to top. If the data set 1608 is required by a system, as the data set 1608 is located in top position of the data structure 1600, therefore the data sets 1602, 1604, 1606 below the data set 1608 will not have to change the position or the sequence, order sequence of data structure 1601 is identical to the data structure 1600. As shown in FIG. 16, after the data set 1608 at the top position of the data structure 1600 is extracted and placed back to the top position, hence the data structure 1601 is identical to the data structure 1600.

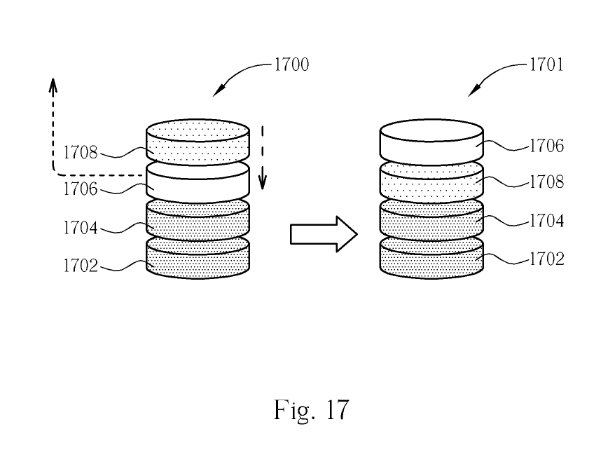

Please refer to FIG. 17. FIG. 17 illustrates a data structure diagram of a practical embodiment of the present invention. In FIG. 17, a data structure 1700 comprises data sets 1702, 1704, 1706 and 1708 arranged in a sequence starting from bottom to top. If the data set 1706 is required by a system, the queuing method of the present invention is capable of extracting and positioning the data set 1706 to the top position of the data structure 1700 to form a data structure 1701. Therefore, in the data structure 1700, the data set 1706 is located below the data set 1708 which is located at the top position of the data structure 1700, and in the data structure 1701, the data set 1706 is extracted and positioned to the top position, therefore the data set 1706 overtook the position of the data set 1708 in the data structure 1701. In FIG. 17, from comparison of the data structures 1700 and 1701, the data sets 1702 and 1704 are not utilized, therefore the sequence and the positions remain the same, only the data set 1706 and the data set 1708 swap positions and order in the sequence.

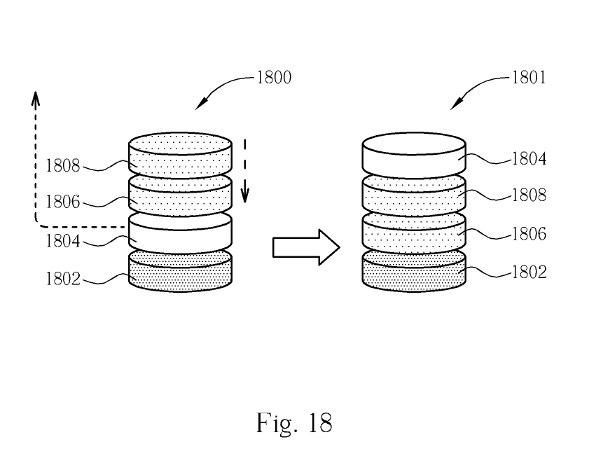

Please refer to FIG. 18. FIG. 18 illustrates a data structure diagram of a practical embodiment of the present invention. In FIG. 18, a data structure 1800 comprises data sets 1802, 1804, 1806, and 1808 arranged in a sequence starting from bottom to top. If the data set 1804 is required by a system, the queuing method of the present invention is capable of extracting and positioning the data set 1804 to the top position of the data structure 1800 to form a data structure 1801. Therefore, in the data structure 1800, the data set 1804 is located below the data sets 1808, 1806 of the data structure 1800, and in the data structure 1801, the dataset 1804 is extracted and positioned to the top position, therefore the data set 1804 leads the data sets 1808 and 1806 in the data structure 1801. In FIG. 18, by comparing the data structures 1800 and 1801, the data set 1802 is not utilized, therefore the position remains the same, after the data set 1804 is moved to the top position of the data structure 1800 to form the data structure 1801, the data set 1808 and the data set 1806 of the data structure 1800 will move a position downwards. Thus, in the data structure 1801, the data sets 1808 and 1806 move a position downwards so that the data set 1804 is placed in the top position of the data structure 1801.

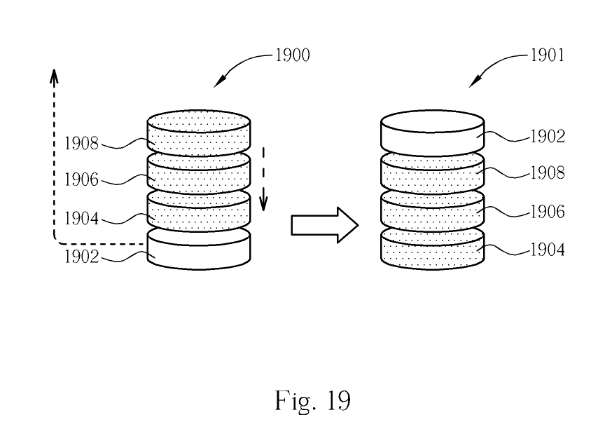

Please refer to FIG. 19. FIG. 19 illustrates a data structure diagram of a practical embodiment of the present invention. In FIG. 19, a data structure 1900 comprises the data sets 1902, 1904, 1906, and 1908. These data sets are arranged in a sequence starting from bottom to top. If the data set 1902 is required by a system, the queuing method of the present invention is capable of extracting and positioning the data set 1902 to the top position of the data structure 1900 to form a data structure 1901. Therefore, in the data structure 1900, the dataset 1902 is located at the lowest position of the data structure 1900, and in the data structure 1901, the dataset 1902 is extracted and positioned to the top position. In FIG. 19, from comparing the data structures 1900 and 1901, after the data set 1902 is moved to the top position of the data structure 1900 to form the data structure 1901, the data set 1908, the data set 1906, and the data set 1804 will move a position downwards. Thus, in the data structure 1901, the data set 1908, 1906 and, 1904 move a position downwards so that the data set 1902 is placed in the top position of the data structure 1901.

Hardware Implementation:

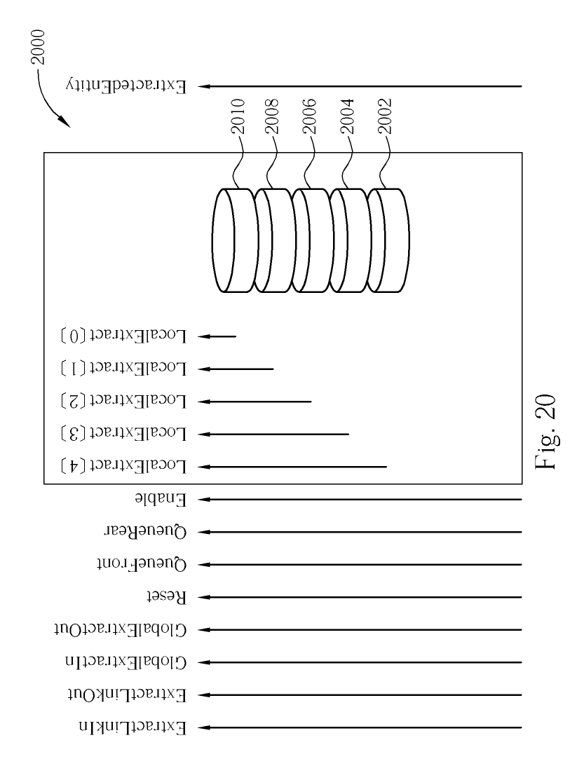

To realize the hardware implementation in the flow as mentioned in the above, a design concept is introduced. For example, in a queue system that comprises five units. Please refer to FIG. 20. FIG. 20 illustrates a design 2000 diagram of hardware implementation of the flow according to the present invention. The design 2000 comprises a data set unit chain formed by data set units 2002, 2004, 2006, 2008 and 2010. The data set units 2002, 2004, 2006, 2008 and 2010 are located in fifth, fourth, third, second, and first position of the data set unit chain. The operation can be executed through the following action:

Reset: All data set units return to initial state;

QueueFront: Front input port of a data set unit chain;

QueueRear: Rear output port of the data set unit chain;

Enable: Enable a storage unit of the data set unit storing data;

Extracted entity: Extract the data set unit indicated;

LocalExtract [4]: Extract and position a data set unit of fifth position of the data set unit chain to a top position;

LocalExtract [3]: Extract and position a data set unit of fourth position of the data set unit chain to a top position;

LocalExtract [2]: Extract and position a data set unit of third position of the data set unit chain to a top position;

LocalExtract [1]: Extract and position a data set unit of second position of the data set unit chain to a top position;

LocalExtract [0]: Extract and position a data set unit of first position of the data set unit chain to a top position.

To conform to hardware implementation of the flow according to the present invention, the design 2000 further comprising the following actions:

GlobalExtractin: Input control of positioning data set unit of lowest position (fifth) of the data set unit chain to top position (first);

GlobalExtractOut: Output control of positioning data set unit of lowest position (fifth) of the data set unit chain to top position (first);

ExtractLinkin: Input unit extracted from data set unit lowest position (fifth) of the data set unit chain;

ExtractLinkOut: Output unit extracted from data set unit lowest position (fifth) of the data set unit chain.

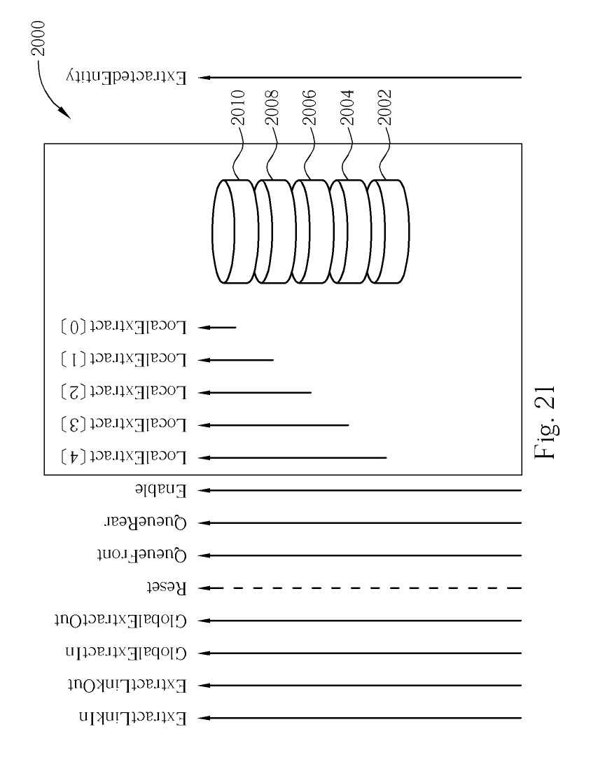

For example, please refer to FIG. 21. FIG. 21 illustrates situation of the design 2000 executing a Reset action. If design 2000 comprises a data set unit chain formed data set units 2002, 2004, 2006, 2008, and 2010 in initial state as shown in FIG. 20. Therefore, in FIG. 21, after executing the Reset action, the data set units 2002, 2004, 2006, 2008, and 2010 of the design 2000 will return to the initial order in the sequence.

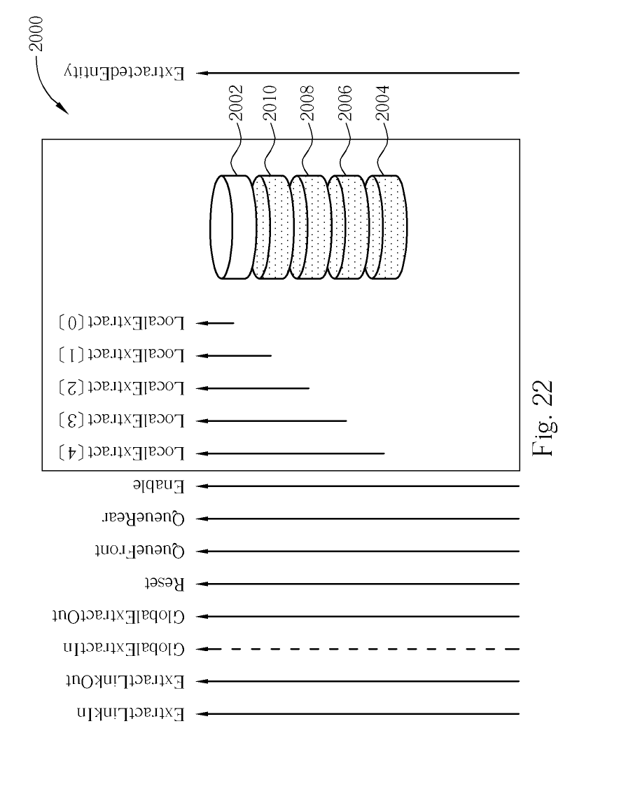

To continue with the example of FIG. 21, please refer to FIG. 22. FIG. 22 illustrates a situation of the design 2000 executing a GlobalExtractin action. As mentioned previously, the GlobalExtractin is utilized to control the design 2000 to position a data set unit of the lowest position of the data set units 2002, 2004, 2006, 2008, and 2010 to the top position. Therefore, as shown in FIG. 22, after executing the GlobalExtractin action, the dataset unit is moved to the top position of the data set unit chain and the sequence of the data set units 2004, 2006, 2008, and 2010 will not change but will be moved a position downwards. Therefore, the first to the fifth position in the sequence of the dataset unit chain starts from the data set unit 2002, 2010, 2008, 2006, and 2004. In short, the GlobalExtractin executes the example of FIG. 19, the data set unit 2002 of the lowest position is moved to the top position of the data set unit chain. Hence, when the data set unit 2002 is read again, the data set unit 2002 is located in the top (first) position of the data set unit chain.

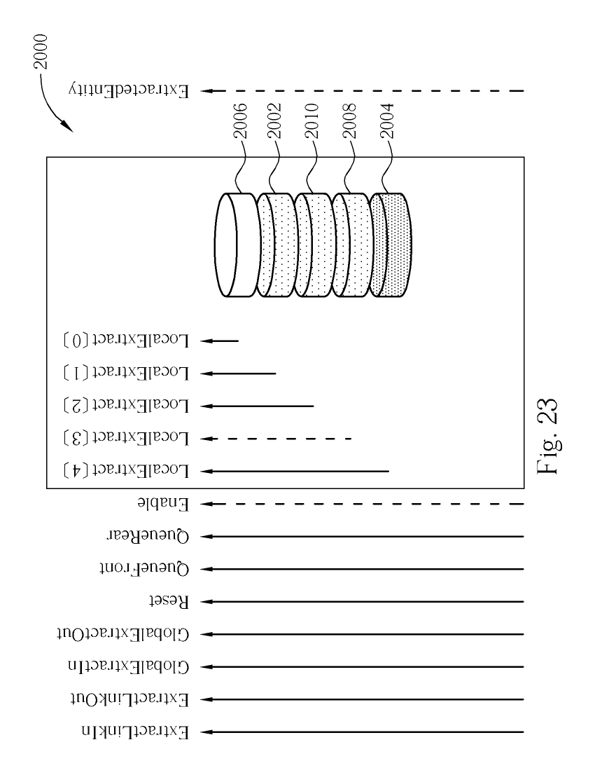

To continue the example of FIG. 22, please continue to refer to FIG. 23. FIG. 23 illustrates a situation of the design 2000 extracting and positioning the data set unit in fourth position of the data set unit chain to the top position. As mentioned previously, an ExtractedEntity action extracts the required data set unit, LocalExtract [3] extracts and positions the data set unit in the fourth position of the data set unit chain to the top position, the action Enable enables the storage unit of the data set unit storing data. In FIG. 22, the data set unit 2006 is located at the fourth position of the data set unit chain, therefore in FIG. 23, the design 2000 executes the ExtractedEntity to extract the required data set unit 2006, and executes the LocalExtract [3] and the Enable to extract and position the data set unit 2006 to the first position of the data set unit chain, and the sequence of the data set units 2002, 2010, 2008 is not changed and the data set units are moved a position downwards. No action is executed on the data set unit 2004; therefore, its position is not changed. In this way, in FIG. 23, the data set units located sequentially in the first to the fifth position of the data set unit chain are the data set units 2006, 2002, 2010, 2008, and 2004. In short, the example of FIG. 23 is similar to executing the example of FIG. 18, when the data set unit 2006 is read again, the data set unit 2006 is already located at the top (first) position of the data set unit chain.

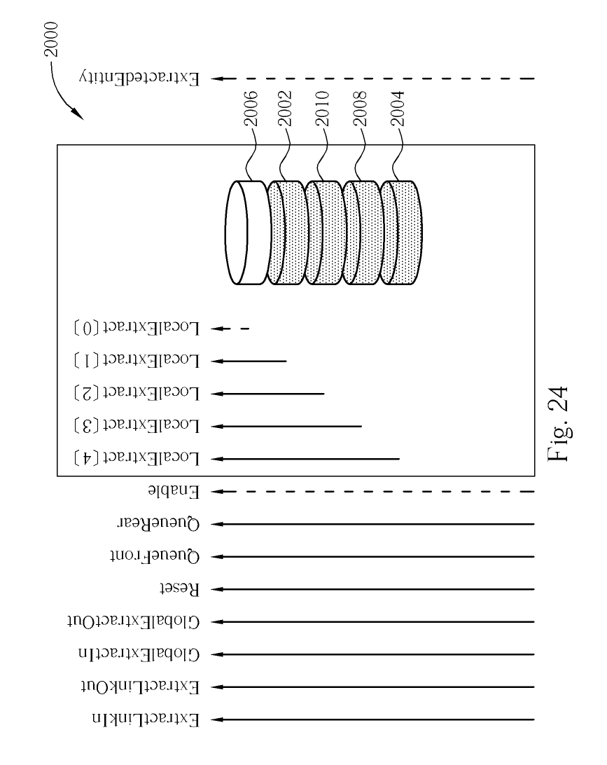

To continue the example FIG. 23, please continue to refer to FIG. 24. FIG. 24 illustrates a situation of design 2000 extracting and positioning a data set unit in a first position of the data set unit chain to the top position. As mentioned previously, an ExtractedEntity action extracts the required data set unit, LocalExtract [0] extracts and positions the data set unit in the first position of the data set unit chain to the top position, but the action Enable enables the storage unit of the data set storage data. In FIG. 23, the data set unit 2006 is located at the first position of the data set unit chain, therefore in FIG. 24, the design 2000 executes the ExtractedEntity to extract the required data set unit 2006, and executes the LocalExtract [0] and the Enable to extract and maintain the first position of the data set unit chain, and the data set units 2002, 2010, 2008, 2004 will not change the order of sequence and no action will be executed, therefore the position will not be changed. In this way, in FIG. 24, the data set units located in the first to the fifth position of the data set unit chain is the same as the sequence of the data set units 2006, 2002, 2010, 2008, and 2004 of FIG. 23. In short, the example of FIG. 24 is like executing the example of FIG. 16, when the data set unit 2006 is read again, the data set unit 2006 is already located at the top (first) the data set unit chain.

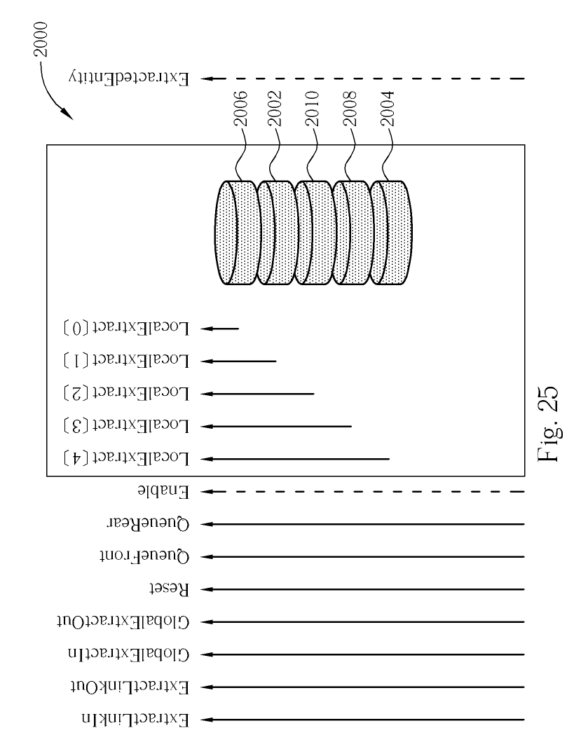

To continue the example of FIG. 24, please continue to refer to FIG. 25. FIG. 25 illustrates a situation where data set units 2002, 2004, 2006, 2008, and 2010 are not required data set units in design 2000. If a data set unit 2012 is required by a system, there is no data set unit 2012 in the data set unit chain of the design 2000. After the design 2000 executes an ExtractedEntity action to extract the required data set unit 2012 and executes an Enable action to enable storage unit of the data set unit storing unit data the design 2000 is able to determine whether there is a data set unit 2012 in the data set unit chain. As a result, the data set units 2002, 2004, 2006, 2008, and 2010 will not execute any action.

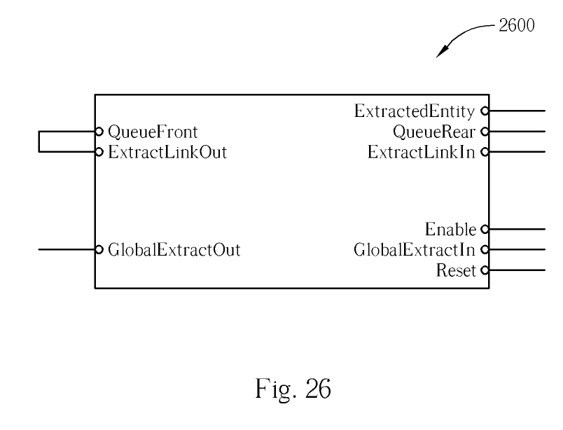

Furthermore, the design 2000 can be regarded as a single component, please refer to FIG. 26. FIG. 26 illustrates a diagram of a basic component 2600 formed by the design 2000 according to the present invention. The basic component 2600 comprises QueueFront pin, ExtractLinkOut pin, GlobalExtractOut pin, ExtractedEntity pin, QueueRear pin, ExtractLinkin pin, Enable pin, GlobalExtractin pin and Reset pin, for executing the actions of the design 2000 of FIG. 20 respectively such as QueueFront, ExtractLinkOut, GlobalExtractOut, ExtractedEntity, QueueRear, ExtractLinkin, Enable, GlobalExtractin and Reset. Data set unit of the design 2000 can be a part of the component 2600 internally, or can be located externally of the component 2600 to be controlled by the basic component 2600. Please take note that when there is only one component 2600, the QueueFront pin can be coupled to the ExtractLinkOut pin to maintain the correct operation.

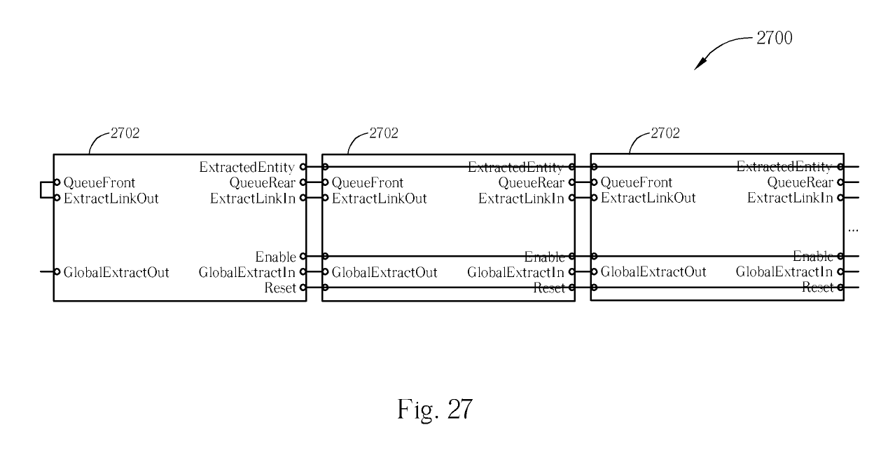

To continue the example of FIG. 26, please continue to refer to FIG. 27. FIG. 27 illustrates a diagram of a chain of components 2700. The chain of components 2700 comprise a plurality of basic components 2702 arranged in a sequence, the basic component 2702 is the basic component 2600 of FIG. 26, therefore each basic component 2702 comprises QueueFront pin, ExtractLinkOut pin, GlobalExtractOut pin, ExtractedEntity pin, QueueRear pin, ExtractLinkin pin, Enable pin, GlobalExtractin pin and Reset pin, for executing the actions of the design 2000 of FIG. 20 respectively such as QueueFront, ExtractLinkOut, GlobalExtractOut, ExtractedEntity, QueueRear, ExtractLinkin, Enable, GlobalExtractin and Reset. To maintain the correct operation, the ExtractLinkOut pin, the Enable pin, and the Reset pin of each level of basic component 2702 are each coupled to the same sequence. Additionally, the QueueRear pin of a preceding level of basic component 2702 is coupled to the QueueFront pin of a next level, the ExtractLinkin pin of the preceding level of basic components 2702 is coupled to the ExtractLinkOut pin of the next level, and the GlobalExtractin pin of the preceding level of basic components 2702 is coupled to the GlobalExtractOut pin of the next level. Please note in FIG. 27, the QueueFront pin is coupled to the ExtractLinkOut pin of first level of basic component 2702 to maintain the correct operation.

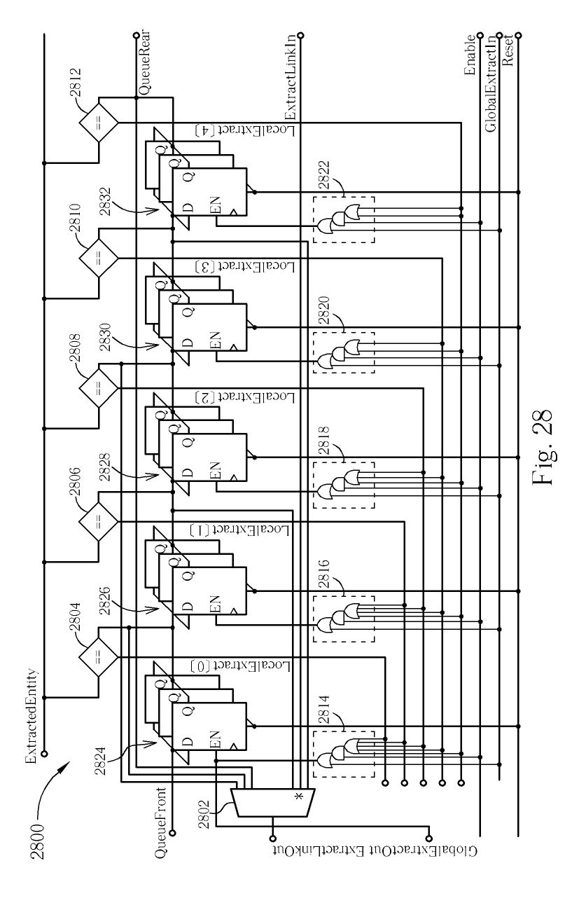

The previously mentioned has established the basic concept of hardware implementation of the present invention; the five levels of data set units will be utilized again as an example. Please refer to FIG. 28. FIG. 28 illustrates a diagram of a least recently used controller 2800 of a storage device. The least recently used controller 2800 comprises a selector 2802, a plurality of comparators 2804, 2806, 2808, 2810, 2812, a plurality of logical gates 2814, 2816, 2818, 2820, 2822. In FIG. 28, the least recently used controller 2800 is coupled to a plurality of storage unit groups 2824, 2826, 2828, 2830, 2832; each storage unit group comprises three D-shaped flip-flops. The comparator of the least recently used controller 2800 is utilized for controlling the storage unit group, coupled to the comparator, according to signal inputted by an ExtractedEntity pin. To provide a more clear explanation, in FIG. 28, a QueueFront pin, an ExtractLinkOut pin, a GlobalExtractOut pin, the ExtractedEntity pin, a QueueRear pin, an ExtractLinkin pin, an Enable pin, a GlobalExtractin pin, and a Reset pin of the least recently used controller, each corresponds to the same pin of the basic component 2600 of the FIG. 26, for executing QueueFront, ExtractLinkOut, GlobalExtractOut, ExtractedEntity, QueueRear, ExtractLinkin, Enable, GlobalExtractin and Reset of the design 2000 of FIG. 20. In the hardware implementation, the comparators 2804, 2806, 2808, 2810, 2812 of the least recently used controller 2800 are utilized for comparing the signals of the storage unit groups 2824, 2826, 2828, 2830, 2832 with the signal of ExtractedEntity pin, when the two correspond, the LocalExtract [0] pin to LocalExtract [4] pin are driven to control enable or disable of the storage unit group and output of the ExtractLinkOut. The logical gates 2814, 2816, 2818, 2820, 2822 each comprises two OR gates and one AND gate, the configuration situation as shown in FIG. 28, for controlling the enable or disable of the corresponding storage unit group according to the signals received from the Enable pin, the GlobalExtractin pin and LocalExtract [0] pin to LocalExtract [4] pin.

According to a storage device controller designed by the queuing method of the queue system of the present invention, each of the storage unit group of the corresponding storage device requires [log 2 N] of storage units, N represents series of the storage unit group. Therefore, the least recently used controller 2800 of FIG. 28, each storage unit group comprises three storage units. For example, for a fully associative mapping, that comprises five memory cell groups of cache memory, and each level of memory cell group requires three memory cells. However, in the prior art, a cache memory that utilizes algorithm of least recently used, each level of memory cell group requires [log 2 M] number of memory cells, N represents the series of the storage unit group. Therefore, for a fully associative mapping comprises five memory cell groups of cache memory, each level of memory cell group requires seven memory cells. In short, according to the storage device controller designed by the queuing method of the queue system of the present invention, the required number of storage units can be reduced.

Practical Application:

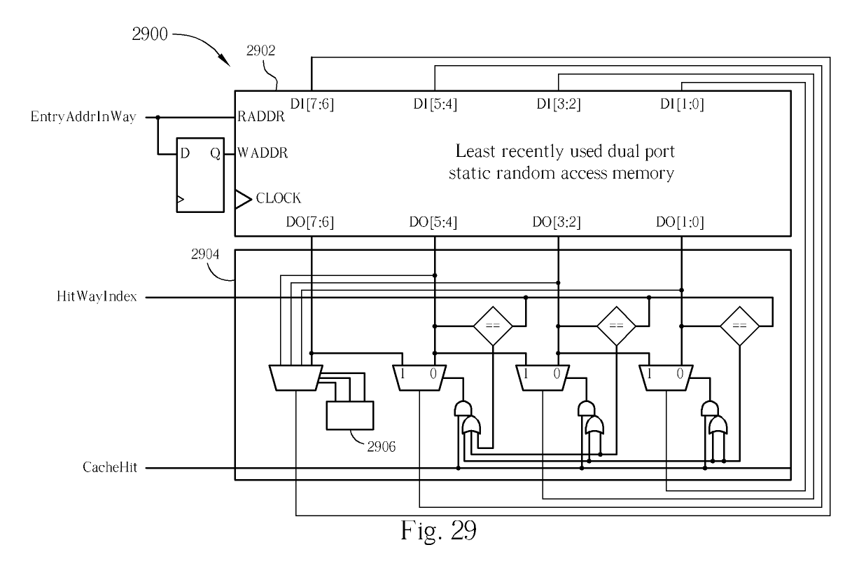

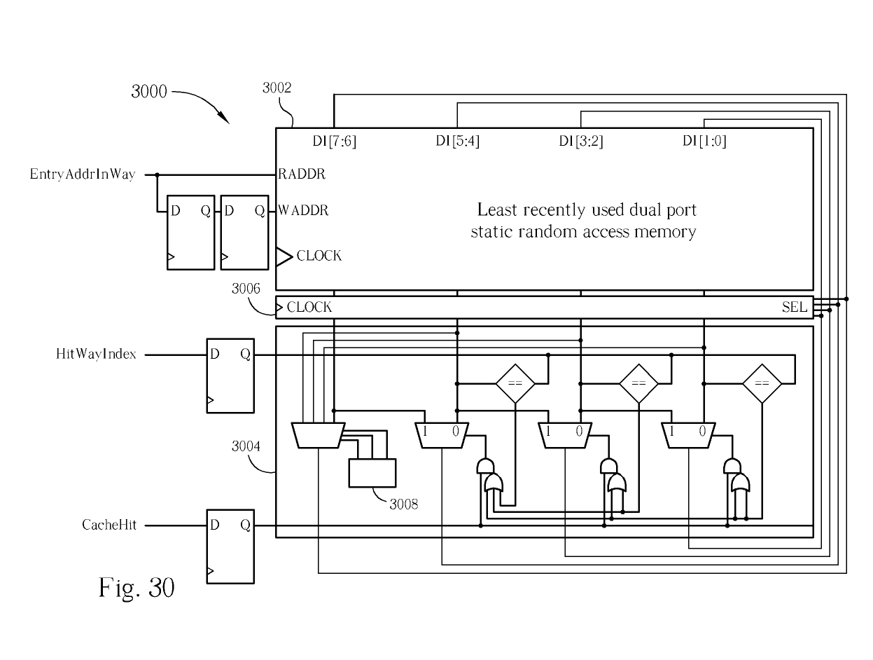

In regards to the practical application of the present invention, please refer to FIG. 29 and FIG. 30. FIG. 29 illustrates a diagram of least recently used control unit 2900 of a four directional set associative cache memory. The least recently used (LRU) control unit 2900 comprises a least recently used dual port static random access memory (SRAM) 2902 and a least recently used memory controller 2904. The LRU control unit 2900 is capable of executing read-in and write-in, an EntryAddrInWay pin is able to input memory address to the LRU dual port SRAM 2902, a HitWayIndex pin is utilized to indicate a hit path, and a CacheHit pin is utilized to indicate a cache memory hit. The LRU dual port SRAM 2902 can generate a read-in address RADDR and write-in address WADDR according to the memory address and clock inputted by the EntryAddrInWay pin, also by control of a set selector 2906 and the LRU memory controller 2904 to execute the read-in and write-in of the LRU cache memory. FIG. 30 illustrates a diagram of another least recently used control unit 3000 of a four directional set associative cache memory. The least recently used (LRU) control unit 3000 comprises a least recently used dual port static random access memory (SRAM) 3002, a least recently used memory controller 3004 and a feedback selector 3006. Therefore, the LRU control unit 3000 is capable of executing read-in, write-in and updating. An EntryAddrInWay pin is able to input memory address to the LRU dual port SRAM 3002, a HitWayIndex pin is utilized to indicate a hit path, and a CacheHit pin is utilized to indicate a cache memory hit. The LRU dual port SRAM 3002 can generate a read-in address RADDR and write-in address WADDR according to the memory address and clock inputted by the EntryAddrInWay pin, also by control of a set selector 3008, the feedback selector 3006 and the LRU memory controller 3004 to execute the read-in and write-in of the LRU cache memory.

In conclusion and in support of the present invention being utilized for the successful implementation of the queuing method and the related electric circuit, and discloses the practical application. The storage device controller of the present invention is capable of utilizing less memory cells of the prior art to achieve the same performance as the prior art, hence reducing production costs. The present invention is capable of achieving the same efficiency with less memory cells to improve and overcome as the prior art fails with fully associative mapping cache memory and the set associative mapping cache memory

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of queuing for a queue system, the queue system comprising a plurality of units, each unit positioned in an order according to a predetermined rule, the queuing method comprising:
extracting and positioning a unit into a first priority position of the queue system according to an extract command.

2. The method of claim 1 wherein the first priority position is a position which is most utilized in the queue system.

3. The method of claim 1 wherein when the unit is extracted and positioned in the first priority position of the queue system, the other units of the queue system move down a position without changing sequence.

4. The method of claim 3 wherein the method further comprises that the units that did not move will remain in their original positions.

5. A method of queuing for a queue system, the queue system comprising a plurality of units, each unit positioned in an order according to a predetermined rule, the queuing method comprising:
inserting and positioning a unit into a first priority position of the queue system according to an insert command; and
removing a unit located in a last position of the queue system.

6. The method of claim 5 wherein the first priority position is a position that is most utilized in the queue system.

7. The method of claim 5 wherein the last position is a position that is least utilized in the queue system.

8. A method of queuing for a queue system, the queue system comprising a plurality of units, each unit positioned in an order according to a predetermined rule, the queuing method comprising:
performing a search on the queue system without changing the sequence of each unit according to a search command.

9. A method of queuing for a queue system, the queue system comprising a plurality of units, each unit positioned in an order according to a predetermined rule, the queuing method comprising:
extracting from a plurality of units and positioning the unit of a last position into a first priority position of the queue system according to a multi-extract command.

10. The method of claim 9 wherein the last position is a position that is least utilized in the queue system.

11. The method of claim 9 wherein the first priority position is a position that is most utilized in the queue system.

12. A method of queuing for a queue system, the queue system comprising a plurality of units, each unit positioned in an order according to a predetermined rule, the queuing method comprising:
changing characteristics of a unit to the characteristics according to a changing characteristics command.

13. The method of claim 12 wherein when the characteristics of the unit are changed to the characteristics according to the changing characteristics command, the sequence of a plurality of units of the queue system remains unchanged.

14. A controller for a storage device, the storage device comprising a plurality of storage unit sets forming into a sequence, each storage unit set comprising a plurality of storage units, the controller comprising:
a selector, coupled to the plurality of storage unit sets, for selecting a storage unit set of a plurality of storage unit sets to transmit signals to a predetermined storage unit set according to a predetermined request;
a plurality of comparators, each comparator corresponding to a storage unit set, for outputting signals from an output port of the storage unit set according to an extract request signal; and
a plurality of logic gate sets, each logic gate set corresponding to a storage unit set, for controlling initialization of the storage unit set according to an enable signal and the extract request signal.

15. The controller of claim 14 wherein each logic gate set comprises:
an OR gate for outputting a first OR gate result according to the extract request signal;
an AND gate for outputting an AND gate result according to the first OR gate result and the enable signal; and
a second OR gate for outputting a second OR to the storage unit set corresponding the logic gate set according to the AND gate result.

16. The controller of claim 15 wherein a plurality of logic gate sets control initialization of the storage unit set according to the enable signal, the extract request signal, a final extract signal, and a reset signal.

17. The controller of claim 16 wherein the final extract signal commands a last level storage unit set of a plurality of storage unit sets of the storage device to move to a first level of the plurality of storage unit sets.

18. The controller of claim 17 wherein the last level storage unit set is a storage unit set that is least utilized in the plurality of storage unit sets of the storage device.

19. The controller of claim 14 wherein each storage unit set of the storage device comprises ┌log₂ N┐ of storage units, N represents the number of plurality of storage unit sets.
